(19) United States
(12) Patent Application Publication
(10) Pub. No.: US 2023/0148205 A1
(43) Pub. Date: May 11, 2023

(54) METHOD OF CALCULATING OPTIMAL EFFECTIVE DISTANCE AND PROVIDING ANALYSIS DATA ON BASIS OF WIND PREDICTION ANALYSIS DATA FOR EFFICIENT HOLE STRATEGY

(71) Applicant: GD Tech, Hwaseong-si (KR)

(72) Inventors: Kookjun KIM, Seoul (KR); Weesoo KANG, Seoul (KR)

(21) Appl. No.: 17/674,451

(22) Filed: Feb. 17, 2022

(30) Foreign Application Priority Data
Nov. 11, 2021 (KR) 10-2021-0155247
Nov. 25, 2021 (KR) 10-2021-0164327

(51) Int. Cl. A63B 71/06; G01W 1/10

(52) U.S. Cl. CPC A63B 71/0622; G01W 1/10; A63B 2220/76; A63B 2102/32

(57) ABSTRACT

A method of calculating an optimal effective distance and providing analysis data on the basis of wind prediction analysis data for an efficient hole strategy includes: a step (a) of collecting and storing wind analysis collection data for wind analysis in a golf course in a database of a management server through a data collector of the management server; a step (b) of analyzing wind information for each shot position in a individual course on the basis of the wind analysis collection data by means of a calculator of the management server which performs wind analysis in a golf course; and a step (c) of configuring a graphic user interface environment for wind analysis on the basis of the wind information analyzed through the step (b) by means of the calculator.

### CROSS-REFERENCE TO RELATED APPLICATION

The present application claims priority to Korean Patent Application No. 10-2021-0164327, filed Nov. 25, 2021 and KR 10-2021-0155247, filed Nov. 11, 2021, the entire contents of which are incorporated herein for all purposes by this reference.

### BACKGROUND

### (a) Technical Field

The present disclosure relates to a method of calculating an optimal effective distance and providing analysis data on the basis of wind prediction analysis data for an efficient hole strategy, and more particularly, to a method of calculating an optimal effective distance and providing analysis data on the basis of wind prediction analysis data for an efficient hole strategy, the method being able to reduce a score error of the wind and improve the skill of a user by analyzing, predicting, and visually providing influence by the wind in a golf course to a user.

### (b) Background Art

Golf is a ball sport in which players hit a ball stopped on courses into predetermined holes with clubs and contend for superiority on the basis of the number of hits until a ball is put into the holes.

In particular, many golf tournaments are recently held all over the world, so pro players actively act and many people enjoy golf at an amateur level rather than a pro level for a hobby, social relationships, etc.

In golf, analysis of courses is also an important factor other than training a personal physical ability in order to reduce the number of hits.

However, analysis of courses is made up to now on the basis of the individual ability of players or determination of an assistant of players.

Recently, algorithms or artificial intelligence techniques are provided to be able to analyze the swing of an individual (Korean Laid-open Patent Publication No. 10-2016-0002585) or to be able to assist operation and management for golf courses, but analysis by specialized algorithms, artificial intelligence, etc. is hardly used for courses required for actual games.

Further, the factor that has the largest influence on the score in golf courses is the weather environment, particularly, the wind. The wind is very irregular, depending on situations, so it is a factor that makes determination of players unclear and greatly reduces the possibility of expected shots.

However, since analysis of the wind also greatly depends on the experiences of people up to now, large score differences may be caused, depending the abilities of individual players. Further even the same player makes a mistake about determination due to various reasons, so there is a problem that the score difference increases.

Meanwhile, a very small number of image media or software that provides wind information exists in the related art, but the amount of information provided by all of these image media and software and it is difficult to intuitionally understand the displayed images, so users have great difficulty in using them.

Accordingly, there is a need for solving these problems.

### SUMMARY OF THE DISCLOSURE

The present disclosure has been made in an effort to solve the problems described above in the related art and an objective of the present disclosure is to provide a method of calculating an optimal effective distance and providing analysis data on the basis of wind prediction analysis data for an efficient hole strategy, the method enabling previous preparation and train by providing an accurate prediction result by analyzing the wind that has large influence in golf courses.

Another objective of the present disclosure is to provide objective and aesthetic wind image information of golf courses through software installed in a mobile device of a user so that the user can usefully use the wind image information.

The objectives of the present disclosure are not limited to the objects described above and other objects will be clearly understood by those skilled in the art from the following description.

In order to achieve the objectives of the present disclosure, a method of calculating optimal effective distance and providing analysis data on basis of wind prediction analysis data for efficient hole strategy includes: a step (a) of collecting and storing wind analysis collection data for wind analysis in a golf course in a database of a management server through a data collector of the management server; a step (b) of analyzing wind information for each shot position in a individual course on the basis of the wind analysis collection data by means of a calculator of the management server which performs wind analysis in a golf course; a step (c) of configuring a graphic user interface environment for wind analysis on the basis of the wind information analyzed through the step (b) by means of the calculator; and a step (d) of transmitting and providing the graphic user interface environment for wind analysis to software installed in a user's terminal by means of an information provider of the management server.

In this case, the wind analysis collection data may include at least any one or more of rounding start time information, required time information for all rounds, required time information for individual courses, geometric information of golf courses, location information of golf courses, past statistical weather information of golf courses, and analysis information for weather forecast.

And, the step (b) may include: a step (b-1) of setting a reference point in detail on the basis of the location of a golf course; a step (b-2) of performing topographic analysis according to a shot position of an individual course; a step (b-3) of analyzing the local weather state of a golf course using the wind analysis collection data; and a step (b-4) of applying the local weather state analysis result of the step (b-3) on the basis of the topographic analysis result and of deriving wind information for each shot position by reflecting an adjustment coefficient.

In addition, the step (c) may include: a step (c1) of creating an arrow image indicating the direction of a wind with respect to the current position of a user on the basis of the wind information derived in the step (b) described above by means of the calculator of the manage server; and a step (c2) of creating a background image, which shows the degree of influence on the bending direction of a shot, which is performed by a user, by a wind at the current position of the user, deeper than the arrow image on the basis of wind information by means of the calculator.

Here, the step (c1) may include: a step (c1-1) of creating an arrow image by disposing the head of the arrow in a corresponding direction in accordance with the direction of a wind based on the current position of a user on the basis of the wind information; a step (c1-2) of determining whether the direction of a wind based on the current position of a user is a direction having a positive influence on a shot carry of the user or a direction having a negative influence on the shot carry is performed; a step (c1-3) of giving a blue-series color to the arrow image created in the step (c1-1) when the direction of a wind based on the current position of a user is a direction having a positive influence on a shot carry of the user; and a step (c1-4) of giving a red-series color to the arrow image created in the step (c1-1) when the direction of a wind based on the current position of a user is a direction having a negative influence on a shot carry of the user.

The step (c1-3) and the step (c1-4) may measure the degree of influence on the shot carry which is the degree of influence on a shot, which is performed by a user, by a wind at the current position of the user and may adjust the transparency of the color that is given to the arrow image in inverse proportion in accordance with the measured degree of influence on the shot carry.

The step (c2) may include: a step (c2-1) of creating the background image deeper than the arrow image; a step (c2-1) of determining the influence on the bending direction of a shot, which is performed by a user, by a wind at the current position of the user on the basis of the wind information; a step (c2-3) of giving a reddish brown-series color to the background image created in the step (c2-1) when it is determined that the wind at the current position of the user influences a shot, which is performed by a user, in a hook direction; and a step (c2-4) of giving a green-series color to the background image created in the step (c2-1) when it is determined that the wind at the current position of the user influences a shot, which is performed by a user, in a slice direction.

In this case, the step (c2-3) and the step (c2-4) may measure the degree of influence on shot bending which is the degree of influence on a shot, which is performed by a user, by a wind at the current position of the user and may adjust the transparency of the color that is given to the background image in proportion in accordance with the measured degree of influence on the shot.

Meanwhile, a step (ex1) of creating an azimuthal assistant line that shows azimuth on the background by means of the calculator may be further performed between the step (c2) and the step (d).

The step (ex1) may create an azimuthal assistant line in a size exceeding an area range of the background when at least any one of saturation and brightness of the background image comes out of a predetermined discrimination easiness reference value in consideration of the color of the azimuthal assistant line.

In addition, a step (ex2) of creating an azimuthal numeral of the arrow image in a region adjacent to the background image by means of the calculator may be further performed between the step (c2) and the step (d).

A step (ex3) of creating an additional property character showing an additional characteristic of a wind at the current position of a user in a region adjacent to the background image by means of the calculator may be further performed between the step (c2) and the step (d).

The method of calculating an optimal effective distance and providing analysis data on the basis of wind prediction analysis data for an efficient hole strategy according to the present disclosure may be provided in a computer-readable storage medium type in which a program for executing the method is recorded.

The method of calculating an optimal effective distance and providing analysis data on the basis of wind prediction analysis data for an efficient hole strategy for achieving the objectives analyzes a wind having a large influence on a golf course and provides an accurate prediction result to a user so that the result can be applied to a course strategy, thereby being able to improve user's ability.

Further, the present disclosure provides a new algorithm that predicts local weather in a golf course by combining studies that influence weather, so there is an advantage that it is possible to increase accuracy and reliability of local weather prediction.

Further, the present disclosure can provide wind information about a current position where a user performs a shot through a visual graphic interface through software installed in a user's mobile terminal, so there is an advantage that a user can simply and usefully use the present disclosure.

The effects of the present disclosure are not limited to those described above and other effects not stated herein may be made apparent to those skilled in the art from claims.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a view showing processes of a method of calculating an optimal effective distance and providing analysis data on the basis of wind prediction analysis data for an efficient hole strategy according to an embodiment of the present disclosure;

FIG. 2 is a view showing a detailed process of a step (b) of the method of calculating an optimal effective distance and providing analysis data on the basis of wind prediction analysis data for an efficient hole strategy according to an embodiment of the present disclosure;

FIG. 3 is a view showing a detailed process of a step (c) of the method of calculating an optimal effective distance and providing analysis data on the basis of wind prediction analysis data for an efficient hole strategy according to an embodiment of the present disclosure;

FIGS. 4A-4D are views representatively showing some wind image information of entire image information that can be provided by the method of calculating an optimal effective distance and providing analysis data on the basis of wind prediction analysis data for an efficient hole strategy;

FIG. 5 is a view showing a detailed process of a step (c1) of the method of calculating an optimal effective distance and providing analysis data on the basis of wind prediction analysis data for an efficient hole strategy according to an embodiment of the present disclosure;

FIG. 6 is a view showing a detailed process of a step (c2) of the method of calculating an optimal effective distance and providing analysis data on the basis of wind prediction analysis data for an efficient hole strategy according to an embodiment of the present disclosure; and

FIG. 7 is a view showing additional processes that can be performed between a step (c2) to a step (d) of the method of calculating an optimal effective distance and providing analysis data on the basis of wind prediction analysis data for an efficient hole strategy according to an embodiment of the present disclosure.

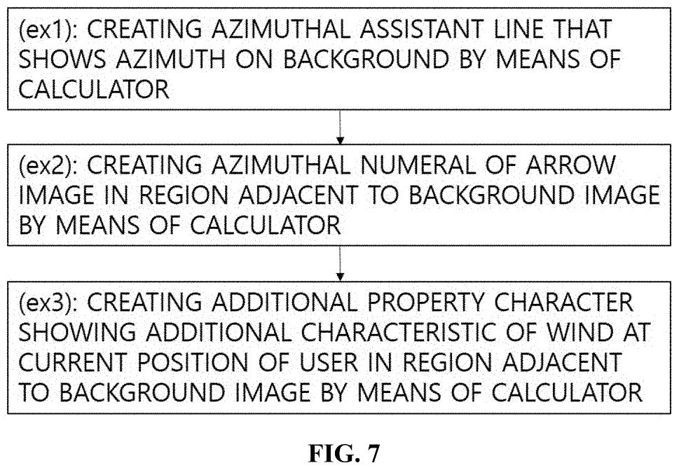

### DETAILED DESCRIPTION

Hereafter, an exemplary embodiment that can achieve the objectives of the present disclosure in detail is described with reference to the accompanying drawings. In the description of the embodiment, the same components are given the same names and reference numerals and are not repeatedly described.

A method of calculating an optimal effective distance and providing analysis data on the basis of wind prediction analysis data for an efficient hole strategy according to the present disclosure is performed by a processor of a computer, a mobile terminal, etc. in which a program for providing an integral wind analysis service for golf courses stored in a storage medium, and software that implements the method may be installed in a computer and driven by a processor.

Further, the program for providing an integral wind analysis service for golf courses that is driven by the processor may be output through an image output device such as a display module, and may provide visual information to a user through a visualized graphic user interface.

That is, information processing by software is implemented in detail through hardware in the present disclosure.

Further, in the following description, a data collector, a calculator, a database, and an information provider may be any one of various items of hardware disposed in a computer or a mobile terminal constituting a management server to perform each function.

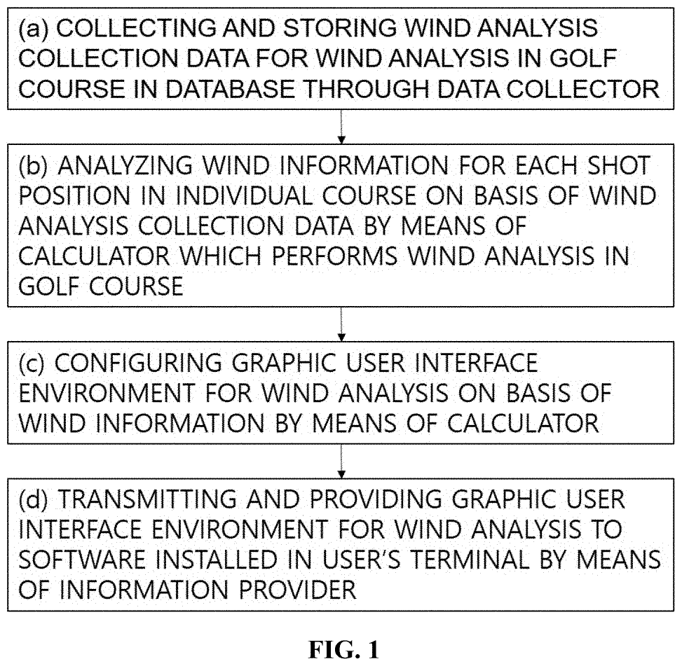

FIG. 1 is a view showing processes of a method of calculating an optimal effective distance and providing analysis data on the basis of wind prediction analysis data for an efficient hole strategy according to an embodiment of the present disclosure.

As shown in FIG. 1, a method of providing a wind analysis service for a golf course according to an embodiment of the present disclosure includes: a step (a) of collecting and storing wind analysis collection data for wind analysis in a golf course in a database of a management server through a data collector of the management server; a step (b) of analyzing wind information for each shot position in a individual course on the basis of the wind analysis collection data by means of a calculator of the management server which performs wind analysis in a golf course; a step (c) of configuring a graphic user interface environment for wind analysis on the basis of the wind information analyzed through the step (b) by means of the calculator; and a step (d) of transmitting and providing the graphic user interface environment for wind analysis to software installed in a user's terminal by means of an information provider of the management server.

Hereafter, the steps (a) to (d) are described in detail.

First, for the method of calculating an optimal effective distance and providing analysis data on the basis of wind prediction analysis data for an efficient hole strategy according to an embodiment of the present disclosure, the step (a) of collecting and storing wind analysis collection data for wind analysis in a golf course in a database of a management server through a data collector of the management server is performed.

In this case, the wind analysis collection data may include at least any one or more of rounding start time information, required time information for all rounds, required time information for individual courses, topographic information of golf courses, location information of golf courses, past statistical weather information of golf courses, and analysis information for weather forecast.

That is, the present disclosure provides an entire logic and calculation that gives help for entire golf decision-making including a process of combining formulaic data (items that can be expressed by numerals) and non-formulaic data (a golf course and a golf environment factor) that are related to golf Next, the step (b) of analyzing wind information for each shot position in an individual course on the basis of the wind analysis collection data by means of a calculator that performs wind analysis in a golf course is performed.

In this step, wind information analysis is performed at the positions of individual shots that a user performs in each course on the basis of the wind analysis collection data.

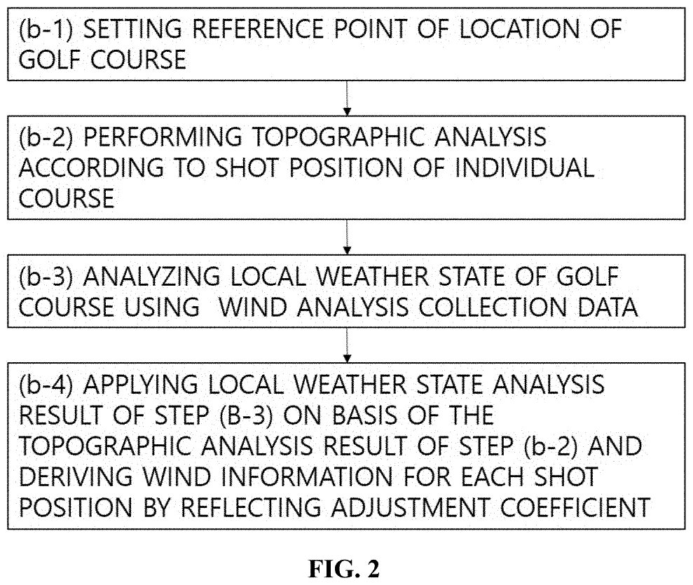

FIG. 2 is a view showing a detailed process of a step (b) of the method of calculating an optimal effective distance and providing analysis data on the basis of wind prediction analysis data for an efficient hole strategy according to an embodiment of the present disclosure.

As shown in FIG. 2, the step (b) may include: a step (b-1) of setting a reference point in detail on the basis of the location of a golf course; a step (b-2) of performing topographic analysis according to a shot position of an individual course; a step (b-3) of analyzing the local weather state of a golf course using the wind analysis collection data; and a step (b-4) of applying the local weather state analysis result of the step (b-3) on the basis of the topographic analysis result and of deriving wind information for each shot position by reflecting an adjustment coefficient.

In the step (b-1), a location-based reference point is set for an entire golf source, which may be made with reference to the address, latitude, longitude, etc. of the corresponding golf course.

In the step (b-2), topographic analysis according to a shot point of an individual course is performed before full-scale wind analysis. This is because the wind analysis result may be changed in accordance with the topography of a shot position, and in this process, an altitude difference at a shot position, the individual effective distance of a stroke, the effective distance of an individual course, the azimuth at a shot position, etc. may be calculated.

In particular, the wind analysis collection data in the step (a) described above may include GPS data, which are collected from a GPS module in a user's mobile terminal, at the current position where the user performs a shot, and accordingly, the calculator of the management server can specify the accurate current location of the user on the basis of the location information of the user.

After topographical analysis according to a shot position of an individual course is performed, as described above, the step (b-3) of analyzing a local weather state of an individual course on the basis of the wind analysis collection data and the step (b-4) of applying the local weather state analysis result of the step (b-3) on the basis of the topographic analysis result and of deriving wind information for each shot position by reflecting an adjustment coefficient are performed.

In the step (b-3), the wind analysis collection data collected in the step (a) described above are used such that a system that can predict the local weather of country clubs using weather information, for example, provided by a world weather information site, etc. and local weather prediction of country clubs of the world including domestic country clubs can be performed.

Further, the step (b-4) derives effective wind direction/wind speed information by matching the wind information at each shot position reflecting a predetermined adjacent coefficient with the local weather state analysis result derived in the step (b-3) on the basis of the azimuth at each shot position for each hole according to geometry based on local weather prediction of courses.

At this time, the wind direction may be calculated in consideration of local weather information of the corresponding day and a tee-shot angle (which may depend on a driver, a second shot, and a third shot).

Further, the wind speed information may be provided for reference to a user together with the wind direction on the basis of local weather information. For example, when the range of a wind speed for each hour is 4-6, the reference wind speed may be displayed as 5 that is the middle value and the actual wind speed range may also be displayed.

Further, the process of analyzing wind information may be performed in consideration of the followings.

1) A headwind has relatively large influence on a distance (e.g., for a woman golfer)
About 1 club for 3˜4 m, a bout 2 clubs for 5·6 m, and about 2.5 clubs for a strong wind of 7 m or more

2) A tailwind reflects about 50% of a headwind

3) Less influence for an uphill and much influence for a downhill

4) More influence by a wind at the west seashore in Korea
There is no windshield forest and coastal wind comes at afternoon
A wind gets intense at about 12:00˜13:00 when a northwest wind, a west wind, and a southwest wind come

5) The higher the trajectory and the lower the ball speed, the more the influence by a wind

In particular, recently, golf players play golf while checking the weather through weather-related software installed in their own mobile terminals in most golf tournaments. However, the intensity of a wind of weather forecast that is generally provided is the intensity of a wind in a common situation rather than the wind specified for country clubs and is the intensity of a wind that does not agree with country clubs designed to reduce the influence by a wind in the design step.

Accordingly, the present disclosure designs a calculation method that can measure the intensity of a wind flowing at a country club by studying the topography of the country club and is designed to more intensively consider a wind factor by testing for about 30 domestic tournaments.

In general, the formula of changing a speed per hour into a speed for second may be applied by dividing the movement distance of a wind per hour by 3600. For example, a formula of (15×1000)/3600 may be applied to change 15 km/hour into a speed per second of m/sec.

In this case, it is possible to find out a wind that agrees with the characteristics of a country club by changing the dominator of the conversion formula as 3600˜6000.

That is, increasing the denominator larger 3600 (changed into seconds from 1 hour) means that the influence of a wind decreases, and decreasing the denominator smaller than 3600 means that the influence of a wind increases. The present disclosure can apply factors to types A, B, C, and D classified on the basis of the latitude/longitude information of the location of each country club.

For example, when a golf course is positioned at the west seashore, 3600˜4000 may be applied as a denominator when a west wind blows, and the denominator may be increased to 4000˜4500 when an east wind blows. By applying this case, the denominator becomes 4000˜6000 at domestic country clubs (mountain areas), but the denominator for holes of golf courses at valleys becomes 3000 in some cases.

Domestic golf courses can be classified largely into four types on the basis of this fact.

A: seashore type golf courses (denominator, 3600˜4500)

B: mountain type golf courses (denominator, 4500˜6000)

C: high mountain type golf courses (denominator, 4000˜5000)

D: Jejudo island type (flatland type) golf courses (denominator, 3600˜5000)

Further, it is possible to predict a wind at each hole in consideration of the angle of the wind together with a tee-shot angle.

Next, the step (c) of configuring a graphic user interface environment for wind analysis on the basis of the wind information analyzed through the step (b) by means of the calculator is performed.

In this process, a process of constructing a graphic user interface environment is performed to visually provide the wind information analyzed in the step (b) through software installed in a user's terminal in the step (d) to be described is performed.

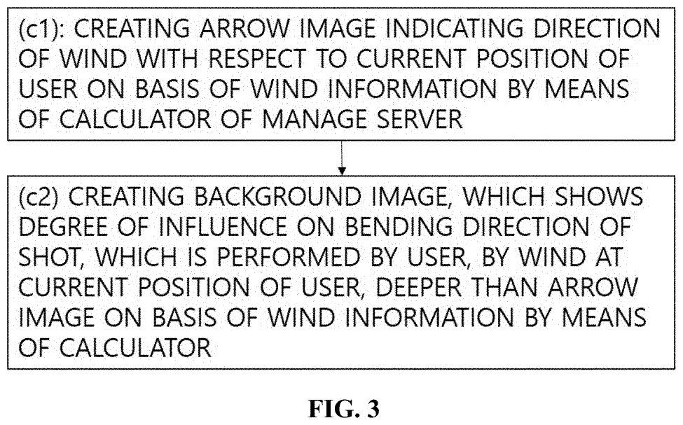

FIG. 3 is a view showing a detailed process of a step (c) of the method of calculating an optimal effective distance and providing analysis data on the basis of wind prediction analysis data for an efficient hole strategy according to an embodiment of the present disclosure.

As shown in FIG. 3, the step (c) includes: a step (c1) of creating an arrow image indicating the direction of a wind with respect to the current position of a user on the basis of the wind information derived in the step (b) described above by means of the calculator of the manage server; and a step (c2) of creating a background image, which shows the degree of influence on the bending direction of a shot, which is performed by a user, by a wind at the current position of the user, deeper than the arrow image on the basis of wind information by means of the calculator.

That is, the calculator combines the position data of a user and wind information and creates wind information image of a golf course a plurality of image processing processes.

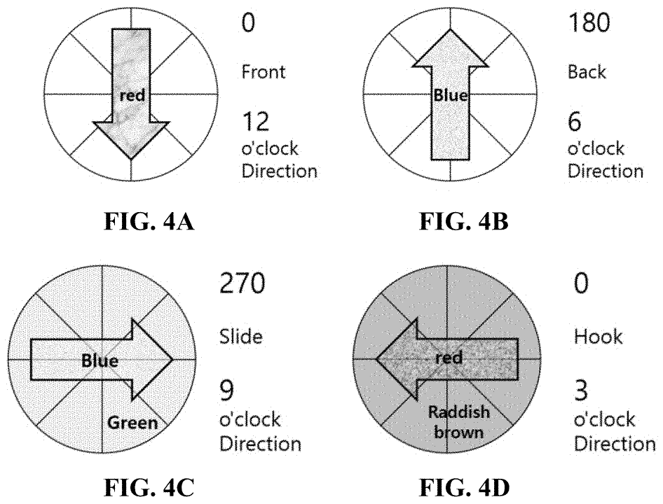

FIGS. 4A-4D are views representatively showing some wind image information of entire image information that can be provided by the method of calculating an optimal effective distance and providing analysis data on the basis of wind prediction analysis data for an efficient hole strategy.

Four items of wind image information having representative characteristics of all items of wind image information that can be displayed are shown in FIGS. 4A-4D. Following processes are described hereafter on the basis of such an example.

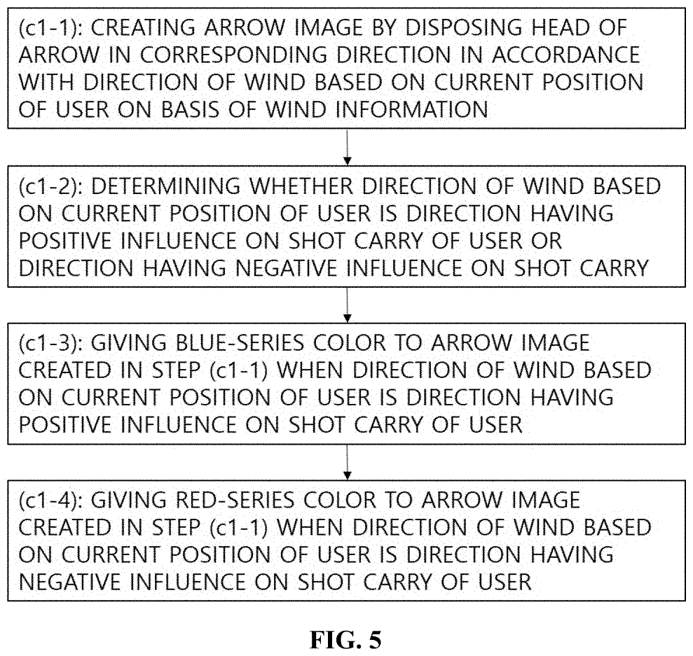

FIG. 5 is a view showing a detailed process of a step (c1) of the method of calculating an optimal effective distance and providing analysis data on the basis of wind prediction analysis data for an efficient hole strategy according to an embodiment of the present disclosure.

As shown in FIG. 5, the step (c1) of the method of calculating an optimal effective distance and providing analysis data on the basis of wind prediction analysis data for an efficient hole strategy according to an embodiment of the present disclosure performs first a step (c1-1) of creating an arrow image by disposing the head of the arrow in a corresponding direction in accordance with the direction of a wind based on the current position of a user on the basis of wind information.

For example, FIG. 4A means that a wind comes from the front, in which an arrow is disposed to face down, and FIG. 4B means that a wind comes from the back, in which an arrow is disposed to face up.

Further, FIG. 4C means that a wind comes from the left, in which an arrow is disposed to face right, and FIG. 4D means that a wind comes from the right, in which an arrow is disposed to face left.

Next, a step (c1-2) of determining whether the direction of a wind based on the current position of a user is a direction having a positive influence on a shot carry of the user or a direction having a negative influence on the shot carry is performed.

Accordingly, a step (c1-3) of giving a blue-series color to the arrow image created in the step (c1-1) may be performed when the direction of a wind based on the current position of a user is a direction having a positive influence on a shot carry of the user, or a step (c1-4) of giving a red-series color to the arrow image created in the step (c1-1) may be performed when the direction of a wind based on the current position of a user is a direction having a negative influence on a shot carry of the user.

The reason is because blue-series colors give a mentally stable feeling in terms of color psychology, so it is possible to intuitionally recognize that the wind currently has a positive influence on the shot carry, and because red-series colors give a mentally unstable feeling, so it is possible to intuitionally recognize that the wind currently has a negative influence on the shot carry.

The step (c1-3) and the step (c1-4) may measure the degree of influence on the shot carry which is the degree of influence on a shot, which is performed by a user, by a wind at the current position of the user and may adjust the transparency of the color that is given to an arrow image in inverse proportion in accordance with the measured degree of influence on the shot carry.

For example, in FIGS. 4A-4B, the arrow images are opaque, so it is possible to intuitionally understand that the degree of influence on a shot carry is large. Further, in FIGS. 4A-4D, the arrow images are more transparent than those in FIGS. 4A-4B, so the backgrounds are seen through the arrow images, whereby it is possible to intuitionally understand that the degree of influence on a shot carry is relatively small.

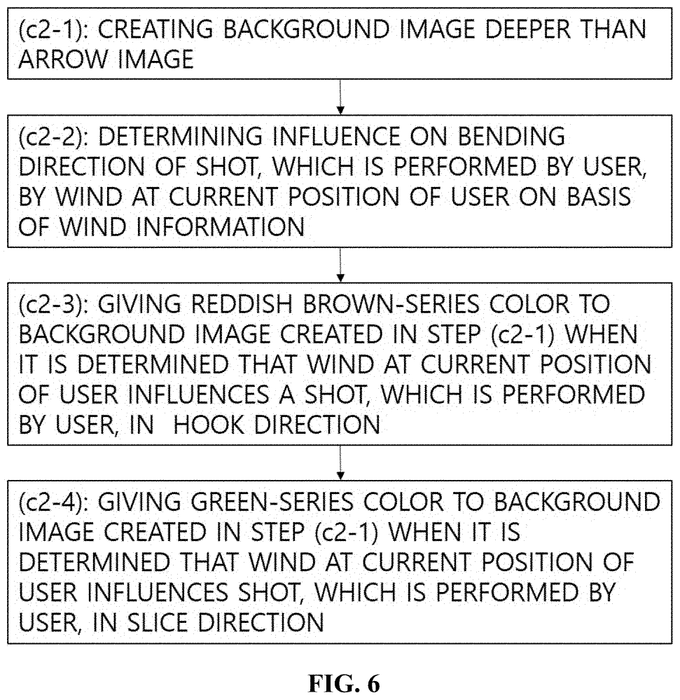

FIG. 6 is a view showing a detailed process of a step (c2) of the method of calculating an optimal effective distance and providing analysis data on the basis of wind prediction analysis data for an efficient hole strategy according to an embodiment of the present disclosure.

As shown in FIG. 6, the step (c2) of the method of calculating an optimal effective distance and providing analysis data on the basis of wind prediction analysis data for an efficient hole strategy according to an embodiment of the present disclosure performs first a step (c2-1) of creating a background image deeper than an arrow image.

In this process, the background image is created deeper than the arrow image to maintain discrimination of the arrow image, and the total area of the arrow image may be included in the area of the background image.

Next, a step (c2-1) of determining the influence on the bending direction of a shot, which is performed by a user, by a wind at the current position of the user on the basis of wind information is performed.

Accordingly, a step (c2-3) of giving a reddish brown-series color to the background image created in the step (c2-1) may be performed when it is determined that the wind at the current position of the user influences a shot, which is performed by a user, in a hook direction, or a step (c2-4) of giving a green-series color to the background image created in the step (c2-1) may be performed when it is determined that the wind at the current position of the user influences a shot, which is performed by a user, in a slice direction.

That is, a user can intuitionally determine whether a current wind influences a shot in the hook direction or a slice direction from the color of the background image.

The step (c2-3) and the step (c2-4) may measure the degree of influence on the shot which is the degree of influence on a shot, which is performed by a user, by a wind at the current position of the user and may adjust the transparency of the color that is given to the background image in proportion in accordance with the measured degree of influence on the shot.

An arrow image and a background image are processed through the step (c1) and the step (c2), and in the following step (c), the information provider collects the images created by the calculator and transmits and provides the images to the software installed in a user's mobile terminal.

That is, the step (d) provides wind information derived by the processes described above to a user through software to which a graphic user interface environment for wind analysis is applied so that the user can apply the wind information to a course strategy and the ability of the user can be improved.

Meanwhile, additional processes of processing various images in addition to an arrow image and a background image may be further performed between the step (c2) and the step (d).

FIG. 6 is a view showing additional processes that can be performed between a step (c2) to a step (d) of the method of calculating an optimal effective distance and providing analysis data on the basis of wind prediction analysis data for an efficient hole strategy according to an embodiment of the present disclosure.

As shown in FIG. 6, at least any one of a step (ex1) of creating an azimuthal assistant line that shows azimuth on a background by means of the calculator, a step (ex2) of creating the azimuthal numeral of an arrow image in a region adjacent to the background image by means of the calculator, and a step (ex3) of creating an additional property character showing an additional characteristic of a wind at the current position of a user in a region adjacent to the background image by means of the calculator may be further performed between the step (c2) and the step (d).

The azimuthal assistant line in the step (ex1) is provided for a user to be able to easily recognize the azimuth angle of the arrow image. Referring to FIGS. 4A-4D, it is possible to see azimuthal assistant lines radially displayed on a background image.

The step (ex1) may create an azimuthal assistant line in a size exceeding the area range of a background when at least any one of the saturation and brightness of the background image comes out of a predetermined discrimination easiness reference value in consideration of the color of the azimuthal assistant line.

This prepares for the case in which the saturation of the background image is similar to that of the azimuthal assistant lines or the brightness of the background image is low, so it is difficult to discriminate the azimuthal assistant lines, in which the azimuthal assistant lines are created in a size exceeding the area range of the background image so that discrimination can be improved. Of course, the discrimination easiness reference value may be changed by various references.

The azimuthal numeral in the step (ex2) is provided for a user to be able to easily recognize the azimuth angle of the arrow image through the numeral. Referring to FIGS. 4A-4D, it is possible to see azimuthal numerals displayed in a region adjacent to the background image.

Further, the additional property character in the step (ex3) is provided for a user to be able to easily recognize additional characteristics of the current wind through the character. Referring to FIGS. 4A-4D, it is possible to see additional property characters displayed in a region adjacent to the background image.

Further, azimuthal numerals and additional property characters are explained in the following Table 1.

TABLE 1

| | | | |
|---|---|---|---|
| Angle | Wind Name | Characteristics | Remarks |

| | | |
|---|---|---|
| 335~25° | headwind | It is a wind having large influence of a headwind. |
| | | A red arrow is relatively deep, and influence of |
| | | hook or slice is relatively small. |
| 30~60° | hook, | It is a wind having influence of both a headwind |
| | headwind | and a hook wind. |
| 65~90° | hook wind | It is a wind having large influence of a hook wind. |
| | | You can seen the color of a red arrow got |
| | | transparent a lot. |
| 95~115° | hook wind | It is a wind having a large influence of a hook |
| | | wind. You can see the color of a blue arrow got |
| | | transparent a lot. |
| 115~150° | hook, | It is a wind having influence of both a tailwind |
| | tailwind | and a hook wind. |
| 155~205° | tailwind | It is a wind having large influence of a tailwind. A |
| | | blue arrow is relatively deep, and influence of |
| | | hook or slice is relatively small |
| 210°~235° | slice, | It is a wind having influence of both a tailwind |
| | tailwind | and a slice wind. |
| 240°~270° | slice wind | It is a wind having a large influence of a slice |
| | | wind. You can see the color of a blue arrow got |
| | | transparent a lot. |
| 275°~295° | slice wind | It is a wind having a large influence of a slice |
| | | wind. You can see the color of a red arrow got |
| | | transparent a lot. |
| 300°~330° | slice, | It is a wind having influence of both a headwind |
| | headwind | and a slice wind. |

Although preferred embodiments of the present disclose were described above, it would be apparent to those skilled in the art that the present disclosure may be achieved in other specific types without departing from the scope or spirit other than the embodiments described above. Accordingly, the embodiments describe above should be considered as being exemplifying rather than limiting, so the present disclosure may be changed within the range of the claims and the equivalent range without being limited to the above description.

What is claimed is:

1. A method of calculating an optimal effective distance and providing analysis data on the basis of wind prediction analysis data for an efficient hole strategy, the method comprising:
a step (a) of collecting and storing wind analysis collection data for wind analysis in a golf course in a database of a management server through a data collector of the management server;
a step (b) of analyzing wind information for each shot position in an individual course on the basis of the wind analysis collection data by means of a calculator of the management server which performs wind analysis in a golf course;
a step (c) of configuring a graphic user interface environment for wind analysis on the basis of the wind information analyzed through the step (b) by means of the calculator; and
a step (d) of transmitting and providing the graphic user interface environment for wind analysis to software installed in a user's terminal by means of an information provider of the management server.

2. The method of claim 1, wherein the wind analysis collection data includes at least any one or more of rounding start time information, required time information for all rounds, required time information for individual courses, geometric information of golf courses, location information of golf courses, past statistical weather information of golf courses, and analysis information for weather forecast.

3. The method of claim 1, wherein the step (b) includes:
a step (b-1) of setting a reference point in detail on the basis of the location of a golf course;
a step (b-2) of performing topographic analysis according to a shot position of an individual course;
a step (b-3) of analyzing the local weather state of a golf course using the wind analysis collection data; and
a step (b-4) of applying the local weather state analysis result of the step (b-3) on the basis of the topographic analysis result and of deriving wind information for each shot position by reflecting an adjustment coefficient.

4. The method of claim 1, wherein the step (c) includes:
a step (c1) of creating an arrow image indicating the direction of a wind with respect to the current position of a user on the basis of the wind information derived in the step (b) described above by means of the calculator of the manage server; and
a step (c2) of creating a background image, which shows the degree of influence on the bending direction of a shot, which is performed by a user, by a wind at the current position of the user, deeper than the arrow image on the basis of wind information by means of the calculator.

5. The method of claim 4, wherein the step (c1) includes:
a step (c1-1) of creating an arrow image by disposing the head of the arrow in a corresponding direction in accordance with the direction of a wind based on the current position of a user on the basis of the wind information;
a step (c1-2) of determining whether the direction of a wind based on the current position of a user is a direction having a positive influence on a shot carry of the user or a direction having a negative influence on the shot carry is performed;
a step (c1-3) of giving a blue-series color to the arrow image created in the step (c1-1) when the direction of a wind based on the current position of a user is a direction having a positive influence on a shot carry of the user; and
a step (c1-4) of giving a red-series color to the arrow image created in the step (c1-1) when the direction of a wind based on the current position of a user is a direction having a negative influence on a shot carry of the user.

6. The method of claim 5, wherein the step (c1-3) and the step (c1-4) measure the degree of influence on the shot carry which is the degree of influence on a shot, which is performed by a user, by a wind at the current position of the user and adjust the transparency of the color that is given to the arrow image in inverse proportion in accordance with the measured degree of influence on the shot carry.

7. The method of claim 4, wherein the step (c2) includes:
a step (c2-1) of creating the background image deeper than the arrow image;
a step (c2-1) of determining the influence on the bending direction of a shot, which is performed by a user, by a wind at the current position of the user on the basis of the wind information;
a step (c2-3) of giving a reddish brown-series color to the background image created in the step (c2-1) when it is determined that the wind at the current position of the user influences a shot, which is performed by a user, in a hook direction; and
a step (c2-4) of giving a green-series color to the background image created in the step (c2-1) when it is determined that the wind at the current position of the user influences a shot, which is performed by a user, in a slice direction.

8. The method of claim 7, wherein the step (c2-3) and the step (c2-4) measure the degree of influence on shot bending which is the degree of influence on a shot, which is performed by a user, by a wind at the current position of the user and adjust the transparency of the color that is given to the background image in proportion in accordance with the measured degree of influence on the shot.

9. The method of claim 4, wherein a step (ex1) of creating an azimuthal assistant line that shows azimuth on the background by means of the calculator is further performed between the step (c2) and the step (d).

10. The method of claim 9, wherein the step (ex1) creates an azimuthal assistant line in a size exceeding an area range of the background when at least any one of saturation and brightness of the background image comes out of a predetermined discrimination easiness reference value in consideration of the color of the azimuthal assistant line.

11. The method of claim 4, wherein a step (ex2) of creating an azimuthal numeral of the arrow image in a region adjacent to the background image by means of the calculator is further performed between the step (c2) and the step (d).

12. The method of claim 4, wherein a step (ex3) of creating an additional property character showing an additional characteristic of a wind at the current position of a user in a region adjacent to the background image by means of the calculator is further performed between the step (c2) and the step (d).

13. A computer-readable storage medium in which a program for executing the method of calculating an optimal effective distance and providing analysis data on the basis of wind prediction analysis data for an efficient hole strategy of claim 1 is recorded.
